(19) United States
(12) Patent Application Publication
(10) Pub. No.: US 2002/0154802 A1
(43) Pub. Date: Oct. 24, 2002

(54) Apparatus for and method of generating an enhanced contrast information digital image

(75) Inventors: Fredrik Goldkuhl, Stockholm (SE); Peter Kovamees, Adelso (SE); Stefan Thunberg, Lidingo (SE)

Correspondence Address: SCHIFF HARDIN & WAITE, 6600 SEARS TOWER, 233 S WACKER DR, CHICAGO, IL, 60606-6473, US

(73) Assignee: Siemens Elema AB

(21) Appl. No.: 10/119,331

(22) Filed: Apr. 9, 2002

(30) Foreign Application Priority Data
Apr. 24, 2001 (SE) 0101421-6

(51) Int. Cl. G06K 9/00

(52) U.S. Cl. 382/132

(57) ABSTRACT

A digital x-ray imaging system has a digital image generator with an x-ray source for irradiating a subject with a radiation beam and a data acquisition system located to detect the radiation after its interaction with the subject, to generate an image of the subject and to emit a digital data set representing the image. A digital image processor is connected to the digital image generator to receive first and second digital data sets respectively representing images obtained at different first and second exposure levels. The processor is configured to generate a third digital data set which when reconstructed provides an enhanced contrast information digital image. The third didgital data set is formed by data extracted from each of the first and the second digital data sets selected as representing regions of different radiation absorbency of the subject, dependent on the respective first and second exposure levels.

### BACKGROUND OF THE INVENTION

1. Field of the Invention

The present invention relates to an apparatus and a method for generating a digital image with enhanced contrast information and in particular to an apparatus and method for generating a digital mammographic image having enhanced image contrast information.

2. Description of the Prior Art

Inspection systems, such as medical imaging systems such as x-ray mammography systems, which produce an image of a subject for visual diagnostic purposes, are increasingly using digital imaging techniques. A digital image acquisition system replaces the optical film system and produces a digital data set which when reconstructed reproduces the image on a display device such as a film sheet or a display screen. However, the electronic cameras, such as those based upon digital detector arrays, which are employed in such acquisition systems may have a digital output of limited dynamic range. Although a charge coupled device (CCD) detector array may have a dynamic range of several thousand, an analoge to digital converter used to digitize the image information may have a dynamic range of about half of this value (a 16-bit converter being able to produce only 1024 grey levels). Therefore, if the subject to be imaged contains portions having highly disparate attenuation or reflection responses to the radiation, then areas of the digital image may become over or under exposed.

For example, in order to produce a transmission image with sufficient contrast information of a portion of the subject which has a relatively high radiation attenuation, relatively high exposure levels are needed. However, at these levels areas of the transmission image corresponding to portions of the imaged subject having a lower radiation attenuation may become overexposed and important contrast information may be lost in the corresponding regions of the transmission image of these portions.

This is particularly a problem in x-ray imaging systems, such as transmission x-ray mammography systems, which are employed to image regions of a patient and where the lost image contrast information could assist in providing a more complete diagnosis. Generally, x-ray attenuation properties of material vary within an imaged region of the patient, for example the necessity to compress the breast in mammography systems leads to thickness variations which result in x-rays being less attenuated toward the periphery of the breast. In order to produce a transmission image of the higher x-ray attenuating material (for example the thicker part of the breast) the region to be imaged must be illuminated with an x-ray beam having a sufficient dose (high exposure level) to enable contrast information of that region to be viewed when the digitized image data set is reconstructed to provide a visible image. Unfortunately, because of the limitation in dynamic range of the electronic camera, the lesser x-ray attenuating material (for example the periphery of the breast) produces a very high intensity region which is indistinguishable from the background when the digitised image data set is reconstructed.

### SUMMARY OF THE INVENTION

It is an object of the present invention to provide a method and a system for generating a digital data set which when reconstructed provides an enhanced information image having improved contrast information, thereby effectively enhancing the dynamic range of the electronic camera used in the digital image acquisition system.

The above object is achieved in accordance with the principles of the present invention in a method, a computer software product, and an apparatus for generating a digital image dataset with enhanced contrast information of a subject, wherein a number of digital datasets are generated, each representing the same image of a subject, with respectively different radiological exposure levels, wherein a reduced digital dataset is identified in each of the aforementioned digital datasets, which represents a different region of the imaged subject that is selected dependent on the radiological exposure level, and wherein the identified reduced digital dataset are combined to generate a digital image dataset having enhanced contrast information.

By generating a number of digital data sets, representing images of a subject obtained at different exposure levels then data from each data set can be extracted which, for each data set, are representative of regions having adequate contrast information A single digital data set including a combination of the extracted data then can be produced which when reconstructed can provide an image on a display device such as a film or display screen having adequate contrast information over an extended region of the originally imaged subject, compared to any of the originally generated data sets.

Images at the different exposure levels can be obtained by either generating the digital data sets at different times throughout a single illumination period of the subject, or preferably by generating the data sets during separate illuminations of the subject with illuminating beams of different beam fluxes but the same energy. In the latter case, one of the beam fluxes, preferably the smallest, may be used for generating an automatic exposure control signal for use in controlling the radiation source to provide the other, preferably larger, beam fluxes.

The inventive method can be employed in the generation of an enhanced information transmission x-ray image of a region of a patient's breast, showing enhanced contrast information, from two digital data sets.

The present invention also is directed to a computer software product having a program code portion which, when run on a computer system, causes the system to operate according to the method of the present invention. Thus the manipulation of the generated data sets to produce a digital data set representing an enhanced contrast information digital image can be carried out on a “stand alone” computer system running the program code portion.

The present invention also is directed to a digital imaging system, such as a transmission x-ray mammography system, configured to operate according to the method of the present invention to produce, from a number of generated digital data sets, a digital data set which, when reconstructed, provides on, for example, a display screen, an enhanced contrast information image, such as a transmission x-ray image of a patient's breast.

### DESCRIPTION OF THE DRAWINGS

FIG. 1 is a schematic representation of a digital imaging system according to the present invention.

FIG. 2 is a flow chart of the method of the present invention implemented in the digital imaging system of FIG. 1.

FIGS. 3A, 3B, 3C and 3D graphically illustrate images obtained according to the methodology shown in FIG. 2.

FIGS. 4A, 4B and 4C respectively show images corresponding to the two graphical representations of FIG. 3A and the graphical representation of FIG. 3D.

### DESCRIPTION OF THE PREFERRED EMBODIMENTS

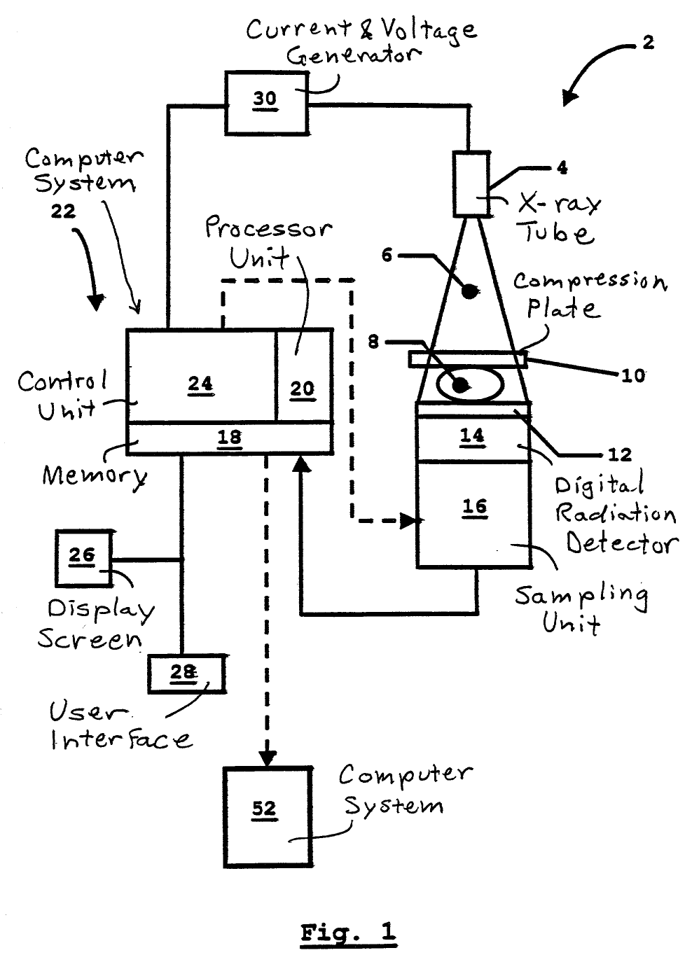

FIG. 1 illustrates a digital imaging system 2 configured for use as a transmission x-ray mammography system. The imaging system 2 has a source of radiation in the form of an x-ray tube 4 which produces an x-ray beam 6 to irradiate a subject breast 8, which is compressed by a compression plate 10 against an imaging surface 12 of a digital radiation detector 14. The digital radiation detector 14 is disposed with respect to the tube 4 so as to collect radiation after the beam 6 has interacted (here shown as being transmitted through, but alternatively may be reflected or scattered from) with the breast 8. The digital detector 14 is of a known type, for example on a CCD, amorphous silicon or amorphous selenium detector array, and is adapted to produce an output representative of the spatial intensity distribution of incident radiation after exposure of the breast 8 to the x-ray beam 6. A sampling unit 16 is operably connected to sample the output from the detector 14 and to generate a digital data set representing the intensity of incident radiation indexed with its spatial location at the detector imaging surface 12. The sampling unit 16 supplies the generated data set to a memory 18 which is accessible by an image processor unit 20. The memory 18 and the processor unit 20 together functionally form a digital image processor and are here shown as part of a suitably programmed computer system 22.

The computer system 22 is further programmed as a control unit 24 which is configured to drive a display screen 26 and to respond to user inputs entered via a user interface 28, such as a conventional computer keyboard. The control unit 24 provides an output signal to a current and voltage generator 30 which is responsive to the output signal to vary the power supplied to the x-ray tube 4 to control the total flux (that is the so-called “milli-amp second (mAs) value”) of the radiation beam 6, and thus the level of exposure of the breast 8 to the x-ray beam 6.

It will be appreciated that an x-ray tube 4 contains an electrical cathode at which electrons are generated and a target anode which, when struck by the accelerated electrons, emits the x-rays which form the x-ray beam 6. Controlling the current and voltage generator 30 to vary the voltage between the cathode and the anode sets the energy of the emitted x-rays whereas controlling the current and voltage generator 30 to vary the current sets the x-ray fluix density. Thus the total x-ray beam flux (or dose) provided by the tube 4 can be varied by varying the duration and/or magnitude of the supplied current (mAs value).

Additionally or alternatively, the control unit 24 may provide a control signal to the sampling unit 16 at a predetermined time. The sampling unit 16 is then adapted to generate and emit a digital data set upon receipt of the control signal, that is after a predefined exposure time of the breast 8 to the beam 6.

In use the control unit 24 provides a first control signal to the current and voltage generator 30 which, in response, supplies current to the x-ray source 4 to generate an x-ray beam 6 having a first dose and energy. The x-ray photons incident on the imaging surface 12 and detected by the detector 14 produce, via the sampling unit 16, a first digital data set representative of an image of the breast 8 obtained at a first exposure level. The first digital data set is supplied from the sampling unit 16 to be received by and stored in the memory 18 (for example RAM, ROM, fixed or removable storage media) of the computer system 22. The control unit 24 then provides a second control signal, which may or may not be generated automatically dependent on the first, to the current and voltage generator 30 which in response, supplies current to the x-ray source 4 to generate an x-ray beam 6 having a second dose and the same energy. The x-ray photons incident on and detected by the detector 14 produce a second digital data set representative of an image of the breast 8 obtained at a second exposure level. This second digital data set is supplied from the sampling unit 16 to be received by and stored in the memory 18 of the computer system 22.

A second embodiment of the present invention is shown in FIG. 1 by the broken line connection between the sampling unit 16 and the control unit 24. In use, the x-ray source 4 generates a beam 6 to irradiate the breast 8 with a single dose of x-rays. The control unit 24 operates during this irradiation to cause the sampling unit 16 to generate and emit first and second digital data sets at two different times. The first and the second digital data sets thus generated each represent an image of the breast 8 respective obtained at the first exposure level and the second exposure level. It will be appreciated by those skilled in the art that a second radiation detector and processing unit combination, identical to that shown in FIG. 1, can be provided. The control unit 24 may then be adapted to control the first and the second combinations sequentially to acquire the first and the second digital data sets at the two different times.

It will be further appreciated by those skilled in the art that since the attenuation properties of a subject breast 8 vary with x-ray beam energy it is important that the beam energy, is kept substantially constant during the acquisition of both the first and the second digital data sets.

Regardless of how the first and the second digital data sets are generated, the image processing unit 20 then operates, as discussed more fully below, to identify in each of the generated data sets a reduced data set that is representative of a region of the breast 8 which was imaged with adequate contrast information. Because of the variations in thickness and thus in the absorption properties of the compressed breast 8, each region will be different for each exposure level. The extracted data from each of the digital data sets are then combined within the image processing unit 20 to produce a final data set representing an image of the breast 8 which contains enhanced contrast information compared to the images represented by either of the first or the second digital data sets. This final data set may be stored in the memory 18 of the computer system 22 and may be suitably processed in the computer system 22 into a video signal which, when supplied to the display screen 26, causes a visible image to be reconstructed for viewing and analysis.

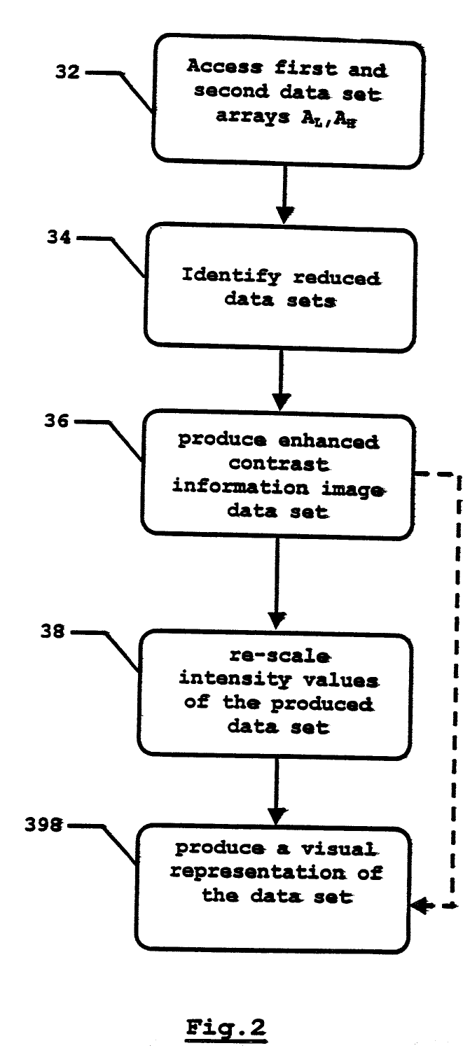

In use, a program code portion of a computer software product is loaded into the memory 18 and run by the computer system 22 to cause the image processing unit 20 to operate according to the flow chart of FIG. 2.

For ease of explanation it is assumed that the first exposure level is a relatively low level which is used to generate the first digital data set. The second exposure level is then a relative high level and generates the second digital data set. These levels can be selected according to the automatic exposure control technique described below. Thus the first digital data set will contain contrast information for a thinner region of the imaged breast 8 and the second digital data set will contain information for a relatively thicker region of the imaged breast 8. It will also be assumed that an intensity value of 4000 in any element of the digital data sets represents a saturation level or the x-ray mammography system of FIG. 1, with a value of O being the minimum intensity value and N being the number of array elements which form each data set.

At step 32 the first data set, being an array A_{L}(1 . . . N) and the second data set, being a corresponding array A_{H}(1 . . . N), are accessed by the image processing unit 20. Each index number 1 . . . N of the array A_{L} corresponds to a pixel (or detector array element) of the detector 14, the spatial location of which in the imaging surface 12 of the detector 14 has been provided within the computer system 22.

At step 34 a reduced data set is identified within each of the data set arrays A_{L}, A_{H} accessed at step 32. Each reduced data set represents a different thickness region of the imaged breast selected based on the contrast information (equivalent to intensity value variations).

In the present example this is achieved by a step-by-step comparison of intensity values in corresponding array elements in each array, A_{L}, A_{H} to identify which of those array elements A_{L}(1 . . . N) of the first data are unsaturated, where the array element A_{H}(1 . . . N) of the second data set having a corresponding spatial location in the image (here evidenced by having the same index number) is saturated. To accomplishthis the array elements A_{L}(1 . . . N) of the first array A_{L} are compared to a predetermined saturation threshold value, delimiting one or more intensity values which represent saturation, to determine which fall outside this “saturation range” as delimited by the threshold value, while the corresponding array elements A_{H}(1 . . . N) of the second array A_{H} fall within the saturation range.

Thus, in the present example, the saturation threshold value may be set to 4000 (producing a saturation range of one); array element A_{H}(1) then is checked to determine if it has a value of 4000. If it does then the corresponding array element A_{L}(1) is checked and if this has a value of less than 4000, the index number (1) of those elements is stored; this is repeated for all remaining elements (2 . . . N). This effectively locates the thinnest parts of the imaged breast. The reduced data set identified from within the array A_{H} is then all the array elements thereof respectively having index numbers that are not stored. The reduced data set identified from within the array A_{L} is all the array elements thereof respectively having index numbers that are stored. It will be appreciated that a saturation threshold value different to the maximum saturation value of 4000 may be employed in the step 34 to set a lower limit for a saturation level so as to ensure that the reduced data sets will contain the contrast information of interest. This threshold value may be selected dependent on the lower exposure level value which effectively determines the contrast detail in the thinner regions of the breast 8 being imaged. Moreover, this threshold value, for example, can be selected based on an empirical rule obtained bycalibration using subjects of known thickness and data sets obtained at known exposure levels. Indeed the saturation threshold values used in the comparisons may be different for each data set, such as for example where a lower exposure level is used at which even those pixels outside the breast region (that is, those directly illuminated by the x-ray beam without passing through breast tissue) do not become fully saturated.

At step 36 an enhanced contrast information image data set is produced as a combination of the reduced data sets identified at step 34.

This may be achieved by substituting the intensity values of those array elements of the higher exposure level array, A_{H}, the index numbers (1 . . . N) of which are stored at step 34, with the intensity values of the array elements with corresponding index numbers (1 . . . N) extracted from the lower exposure level array, A_{L}.

A step 38 is preferably included in which the intensity of the enhanced contrast information image data set produced at step 36 are re-scaled to remove the abrupt change in intensity level values of the thus-produced array, which corresponds to the “boundary” in that array between array elements from each of the two arrays A_{L}, A_{H} accessed at step 32.

This may be achieved in the present example simply by adding the saturation level value, here 4000, to the intensity values of those array elements of the lower exposure level array A_{L} which constitute the reduced data set employed at step 36. This effectively increases the dynamic range of the system of FIG. 1 from 0-4000 to 0-8000.

A step 39 may be included in which the enhanced contrast information image data set, preferably produced at step 38, is converted into a video signal which is employed to drive a display device to display a visual reconstruction of the image represented by the data set.

It will be appreciated that some or all of the program code portion of the computer software product may be additionally or alternatively run by a computer system 52 (see FIG. 1) at a location remote from the site at which the images of the breast 8 are generated. A remote link (illustrated by the broken arrow in FIG. 1) needs to be provided to allow access to the first and the second data sets at the equivalent step 32.

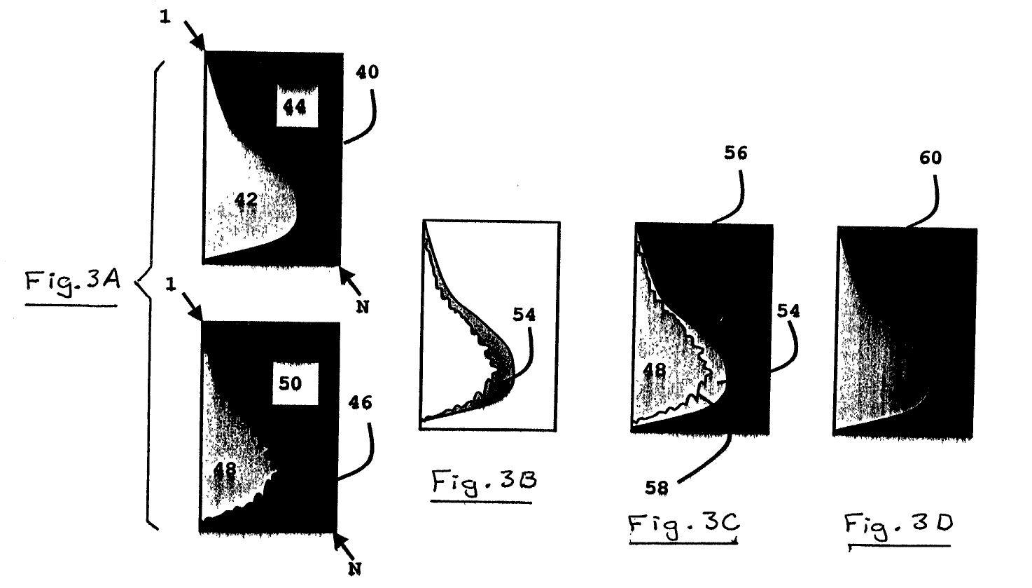

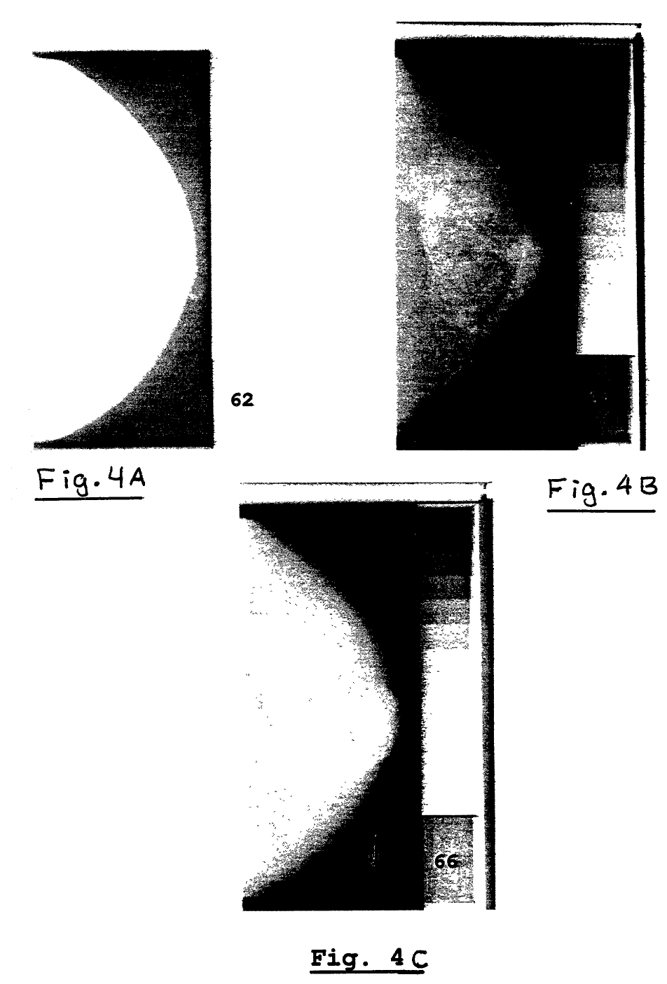

The method according to the present invention, and as implemented when the program code portion described above is run, is represented graphically at FIGS. 3A to 3D with actual images corresponding to the graphical representations 40 and 46 of FIG. 3A and 70 of FIG. 3D, obtained using a system similar to that of FIG. 1, being shown in FIGS. 4A, 4B and 4C, respectively.

In FIGS. 3A, a visual image 40 reconstructed from the representative digital data set A_{L} (1 . . . N) is shown. The locations of the first pixel (1) and the last pixel (N) of a generally rectangular imaging surface (12 of FIG. 1) of a digital radiation detector (14 of FIG. 1) are also shown. The visual image 40 has a region 42 representing an imaged breast, and a region 44 of substantially uniform intensity, representing a saturated region.

FIG. 3A shows a visual image 46 similarly reconstructed from the digital data set A_{H} (1 . . . N). As can be seen the visual image 46 has a region 48 also representing the imaged breast, but which is less extensive than that region 42 of the image 40. A region 50 represents a saturated region.

The data sets A_{L} and A_{H} are those accessed at step 32 above.

As is shown in FIG. 3B, an area 54 can be identified within the imaged breast region 42 of the image 40 shown in FIG. 3A where the intensity values of the corresponding array elements A_{L}(1 . . . N) are not equal to the saturation intensity value but where, in the second image 46 shown in FIG. 3A, those array elements A_{H}(1 . . . N) representing the same location within that second image 46 have a value equal to the saturation value. From this identified area 54 a reduced data set from within each of the original data sets A_{L}, A_{H} is identified in the manner described with regard to step 34 above. These two identified reduced data sets are then combined to form an enhanced contrast information image data set as described with regard to step 36 above. This data set when reconstructed produces an image 56 as shown in FIG. 3C. As can be seen the image 56 contains an abrupt boundary 58 between the area 54 of FIG. 3B, which corresponds to a peripheral (or ‘skinline’) portion of the imaged breast region 42 of the image 40 shown in FIG. 3A, and the imaged breast region 48 of the image 46 is also shown in FIG. 3A. Moreover, contrary to what a physician normally carrying out interpretations of mammographic images would expect, the area 48 is generally lighter (lower intensity values) than the remaining imaged breast region 44. In order to reduce the visual impact of the boundary 58 and to produce an image 60 of the breast having an ‘expected’ general contrast variation, re-scaling of the intensity values of the enhanced contrast information image data set according to step 38 described above is preferred. The re-scaling produces an enhanced contrast information image data set which, when reconstructed provides a visual image 60 as illustrated in FIG. 3D.

FIG. 4A shows an actual mammographic image 62 obtained at an exposure level of 5 mAs, which corresponds to the graphical image 40 shown in FIG. 3A. As can be seen the majority of the imaged breast is white, which indicates underexposure, and only a thin region (skinline) around the periphery of the breast contains useful image contrast information. An actual mammographic image 64 obtained at an exposure level of 120 mAs is shown in FIG. 4B and corresponds to the graphical image 46 shown in FIG. 3A. As can be seen useful contrast information is present in the majority of the imaged breast which corresponds to the white region of the imaged breast in the image 62 obtained at 5 mAs. The skinline contrast information contained in that image 62, has however, been lost and has become black. This indicates saturation or overexposure of the image 64 in this skinline region. An image 66 is shown in FIG. 4C which is a visual re-construction of the enhanced contrast information image data set, after re-scaling, and corresponds to the graphical image 60 of FIG. 3D.

### Automatic Exposure Control (AEC)

The technique of AEC of a digital imaging system is well known. The application of AEC in a digital transmission x-ray mammography system is disclosed in, for example, U.S. Pat. No. 6,018,565. Here a first digital data set, representing first image obtained at a first, typically lower, exposure level, is analyzed (with or without background data removed)using histogram analysis to determine an average grey scale value. A new, second, typically higher, exposure level is then calculated using this average value which will produce a second image with a contrast information optimized for the subject 8.

According to the present invention, exemplified by the description of FIG. 1, the power supply 30 is controlled to supply to the source 4 a current with a first mAs value with which the first digital data set is generated, representative of an image of the breast 8 obtained at the first exposure level. This first mAs value is selected to provide adequate contrast information at the periphery of the breast (that is, in thinner regions) and constitutes the lower of the two exposure levels. This can be done manually via the interface 28 or automatically dependent on the thickness of the compressed breast as measured, for example, by the distance of the compression plate 10 from the detector imaging surface 12. Look-up tables of mAs value versus thickness can be stored in the memory 18 of the computer system 22 for access by the control unit 24. The image processor 20 then undertakes a histogram analysis of the first digital data set and AEC is provided by the control unit 24 which controls the power supply 30 to supply a second mAs value to the x-ray source 4, with which the second digital data set is generated, representative of an image of the breast 8 obtained at the second, higher, exposure level.

It will be appreciated by those skilled in the art that the higher exposure level may be used to set the mAs value for the lower exposure level. However, it is preferable to set the higher exposure level using the lower exposure level, as described above, so as to minimize the x-ray dose received by the subject 8.

Although modifications and changes may be suggested by those skilled in the art, it is in the intention of the inventors to embody within the patent warranted hereon all changes and modifications as reasonably and properly come within the scope of their contribution to the art.

We claim as our invention:

1. A method for generating a digital image data set, representing an image of a subject, containing enhanced contrast information, said method comprising the steps of:
supplying a plurality of digital data sets, respectively obtained by irradiation of a subject at different exposure levels, to a digital signal processor and, in said digital signal processor, identifying a reduced digital data set in each of said plurality of digital data sets, each reduced digital data set representing a different region of said subject contained within said image selected dependent on the exposure level at which the respective digital data set was obtained,there by obtaining a plurality of reduced digital data sets; and
combining said plurality of reduced digital data sets to generate a digital image data set having enhanced contrast information.

2. A method as claimed in claim 1 comprising:
irradiating said subject with two successive penetrating radiation beams respectively having differing durations and substantially identical energies;
detecting a spatial intensity distribution of each of said two successive radiation beams after their respective interaction with said subject; and
from the respective detected spatial intensity distributions, generating a first digital data set of intensity values indexed as to spatial location in a first image of said subject and a second digital data set of intensity values indexed as to spatial location in a second image of said subject, and supplying said first and second digital data sets to said signal processor as said plurality of digital data sets.

3. A method as claimed in claim 2 wherein the step of identifying reduced digital data sets comprises, in each of said first digital data set and said second digital data set, comparing respective intensity values in the first and second digital data sets, having a same spatial location, with a threshold saturation value and retaining only intensity values in one of said first and second data sets which exceed said threshold saturation value and retaining only intensity values in the other of said first and second digital data sets which are below said threshold saturation value.

4. A method as claimed in claim 1 comprising:
irradiating said subject with a penetrating radiation beam;
detecting a spatial intensity distirbution of said radiation beam after interaction with said subject at two successive time intervals to respectively produce a first image and a second image; and
generating a first digital data set of intensity values indexed as to spatial location in said first image and generating a second digital data set of intensity values indexed as to spatial location in said second image, and supplying said first and second digital data sets to said digital signal processor as said plurality of digital data sets.

5. A method as claimed in claim 4 wherein the step of identifying reduced digital data sets comprises, in each of said first digital data set and said second digital data set, comparing respective intensity values in the first and second digital data sets, having a same spatial location, with a threshold saturation value and retaining only intensity values in one of said first and second data sets which exceed said threshold saturation value and retaining only intensity values in the other of said first and second digital data sets which are below said threshold saturation value.

6. A computer software product having a program code stored in a computer-readable medium and loadable into a computer to cause said computer to perform:
a step of accessing a plurality of digital data sets respectively obtained at different radiation exposure levels, each representing an image of a subject;
a step of identifying a reduced digital data set in each of said plurality of digital data sets, each reduced digital data set representing a different region of said subject contained within said image selected dependent on the exposure level at which the respective digital data set was obtained, thereby obtaining a plurality of reduced digital data sets; and
a step of combining said plurality of reduced digital data sets to generate a digital image data set having enhanced contrast information.

7. A computer software product as claimed in claim 6 wherein said plurality of digital data sets comprise:
a first digital data set of intensity values at a first exposure level indexed as to spatial location in a first image of said subject and a second digital data set of intensity values at a second exposure level indexed as to spatial location in a second image of said subject, and wherein said computer software program causes said computer to perform, for identifying said reduced digital data sets, steps of in each of said first digital data set and said second digital data set, comparing respective intensity values in the first and second digital data sets, having a same spatial location, with a threshold saturation value and retaining only intensity values in one of said first and second data sets which exceed said threshold saturation value and retaining only intensity values in the other of said first and second digital data sets which are below said threshold saturation value.

8. A digital imaging system comprising:
a radiation source of irradiating a subject with penetrating radiation at a plurality of different radiation exposure levels and a radiation detector for detecting said radiation to generate respective digital data sets, each represeneting an image of said subject, for said different exposure levels; and
a digital image processors supplied with said plurality of digital data sets which identifies a reduced digital data set in each of said plurality of digital data sets, each reduced digital data set representing a different region of said subject contained within said image selected dependent on the exposure level at which the respective digital data set was obtained, to obtain a plurality of reduced digital data sets, and which combines said plurality of reduced digital data sets to generate a digital image data set having enhanced contrast information.

9. A digital imaging system as claimed in claim 8 wherein said radiation source irradiates said subject with two successive radiation beams respectively having differing durations and substantially identical energies and wherein said detector detects a spatial intensity distribution of each of said two successive radiation beams after their respective interaction with said subject, and from the respective detected spatial intensity distributions, generates a first digital data set of intensity values indexed as to spatial location in a first image of said subject and a second digital data set of intensity values indexed as to spatial location in a second image of said subject, and supplyies said first and second digital data sets to said signal processor as said plurality of digital data sets.

10. A digital imaging system as claimed in claim 9 wherein said digital image processor identifies reduced digital data sets in each of said first digital data set and said second digital data set, by comparing respective intensity values in the first and second digital data sets, having a same spatial location, with a threshold saturation value and retaining only intensity values in one of said first and second data sets which exceed said threshold saturation value and retaining only intensity values in the other of said first and second digital data sets which are below said threshold saturation value.

11. A digital imaging system as claimed in claim 8 said radiatin source irraidates said subject with a radiation beam, and wherein said radiation detector detects a spatial intensity distirbution of said radiation beam after interaction with said subject at two successive time intervals to respectively produce a first image and a second image, and generates a first digital data set of intensity values indexed as to spatial location in said first image and generates a second digital data set of intensity values indexed as to spatial location in said second image, and supplies said first and second digital data sets to said digital signal processor as said plurality of digital data sets.

12. A digital imaging system as claimed in claim 11 wherein said digital image processor identifies reduced digital data sets in each of said first digital data set and said second digital data set, by comparing respective intensity values in the first and second digital data sets, having a same spatial location, with a threshold saturation value and retaining only intensity values in one of said first and second data sets which exceed said threshold saturation value and retaining only intensity values in the other of said first and second digital data sets which are below said threshold saturation value.

13. A digital imaging system as claimed in claim 8 wherein said radiation source is an X-ray source and wherein said radiation detector is an X-ray detector which detects X-rays from said X-ray source after penetrating through said subject, and wherein said digital imaging system further comprises a compression arrangement adapted to receive and compress a patient's breast as said subject, said compression arrangement being disposed to locate said breast in said X-ray beam.
